(19) United States
(12) Patent Application Publication
(10) Pub. No.: US 2016/0189905 A1
(43) Pub. Date: Jun. 30, 2016

(54) Protection Device Employing Current Limiting Fuse and Vacuum Fuse

(71) Applicant: EATON CORPORATION, Cleveland, OH (US)

(72) Inventor: Scott Raymond Lanning, Conway, PA (US)

(73) Assignee: EATON CORPORATION, CLEVELAND, OH (US)

(21) Appl. No.: 14/587,238

(22) Filed: Dec. 31, 2014

(51) Int. Cl. H01H 85/143; H01H 85/02

(52) U.S. Cl. CPC H01H 85/143; H01H 85/0241; H01H 2223/002

(57) ABSTRACT

A non-current limiting vacuum fuse employs a fusible assembly having a pair of electrodes and a fusible element that is situated therebetween. The fusible assembly is a rigid, self-supporting unitary structure that is brazed to an envelope when manufactured inside a vacuum furnace. The fuse provides improved interruption capability and/or a higher voltage rating at reduced cost. The fuse may be used individually, or a plurality of the fuses can be connected together in series to provide enhanced interruption capability and/or a higher voltage rating. The fuse can be connected in parallel with a current limiting fuse to form a vacuum current commutating fuse that provides the benefits of both types of fuses.

### BACKGROUND

1. Field

The disclosed and claimed concept relates generally to electrical distribution equipment and, more particularly, to a vacuum fuse.

2. Related Art

Numerous types of circuit interruption devices are known for use in protecting electrical circuits. For instance, circuit breakers, vacuum interrupters, fuses, and the like are all well-known devices that interrupt current under certain pre-established conditions such as various overcurrent conditions, under-voltage conditions, and other conditions. Certain of these electrical interruption devices are usable through multiple operation cycles, such as the way in which a circuit breaker can be tripped and reset and is thus further usable to protect the same circuit. Other electrical interruption devices such as fuses are operable only once to interrupt current and must then be replaced afterward.

Fuses of many types of known in the relevant art. Conventional fuses, also known as non-current limiting fuses, include a fusible element which is electrically connected between a pair of electrodes that are connected with the circuit. The fusible element melts as a result of a current overload condition, and the melting of the fusible element interrupts the overload current that had been passing therethrough. Such non-current limiting fuses are known to be operable to interrupt three to five times the rated current for the fuse.

In circuits having a risk of a short circuit condition wherein the current flow can be one or more orders of magnitude greater than an overload current, a current limiting fuse is preferred over a non-current limiting fuse for greater interruption capability. A current limiting fuse typically includes a specially figured fusible element that provides a very long arc length that is configured to enable interruption of short circuit current levels. Such a fusible element can be of an extremely long length and of a very small cross section (i.e., a very thin gauge) so that the entire fusible elements fuses at once, resulting in an extremely long arc length between the two electrodes, thereby interrupting the short circuit current.

The elongated fusible element of a current limiting fuse may be wound in a helical fashion along the fuse's longitudinal extent. Such current limiting fuses typically also include a filler material inside the fuse that is silica-based and which fuses along with the fusible elements to form a glass-like material inside the fuse after operation of the fuse.

The fusible element may alternatively be configured of an elongated conductive element that is of a relatively larger gauge but its formed with notches or holes spaced along its length to provide narrowed regions where heating of the fusible element will be concentrated during the melting operation as a result of a short circuit. In such a situation, the result is a large number of series-arranged arcs that together provide a large arc length. The arc or arcs have an arc voltage that is opposite the circuit voltage, and this helps to stop the current flow when the current limiting fuse operates.

Such fuses, while generally effective for their intended purposes, have not been without limitation. Non-current limiting fuses have had limited interruption capability, and the cost to provide enhanced interruption capability has been found to be excessive. Current limiting fuses have been found to be susceptible of unintended operation in certain situations, as transitory high current situations such a motor startups and the like. In order to implement a current limiting fuse into a circuit, significant effort typically must be invested to fine tune the specifications and properties of the current limiting fuse in the circuit so that the fuse will operate appropriately yet will not operate in situations where operation of the fuse is not desired. Improvements would therefore be desirable.

### SUMMARY

An improved non-current limiting vacuum fuse employs a fusible assembly having a pair of electrodes and a fusible element that is situated therebetween. The fusible assembly is a rigid, self-supporting unitary structure that is brazed to an envelope when manufactured inside a vacuum furnace. The fuse provides improved interruption capability at reduced cost. The fuse may be used individually, or a plurality of the fuses can be connected together in series to provide enhanced interruption capability. The fuse can be connected in parallel with a current limiting fuse to form a vacuum current commutating fuse that provides the benefits of both types of fuses.

Accordingly, an aspect of the disclosed and claimed concept is to provide an improved fuse having improved performance.

Another aspect of the disclosed and claimed concept is to provide an improved fuse at a reduced cost.

Another aspect of the disclosed and claimed concept is to provide a fuse that is usable in a variety of different ways that provide enhanced performance.

Accordingly, an aspect of the disclosed and claimed concept is to provide an improved protection device that is structured to be electrically connected with a protected portion of an electrical circuit. The protection device can be generally stated as including a current limiting fuse structured to interrupt a short circuit current; a non-current limiting fuse structured to interrupt an overload current and which can be generally stated as including an envelope having a hollow interior region, a pair of electrodes, and a fusible element, the pair of electrodes being situated on the envelope, the fusible element being electrically interposed between the pair of electrodes, the fusible element being situated within the interior region, the interior region having a reduced pressure therein, and an electrical connection apparatus that electrically connects together in parallel the current liming fuse and the non-current limiting fuse.

### BRIEF DESCRIPTION OF THE DRAWINGS

A further understanding of the disclosed and claimed concept can be gained from the following Description when read in conjunction with the accompanying drawings in which:

FIG. 1 is a perspective view, partially cut away, of an improved fuse in accordance with a first embodiment of the disclosed and claimed concept;

FIG. 2 is an exploded view, partially cut away, of the fuse of FIG. 1;

FIG. 3 is a perspective view, partially cut away, of an improved protection device in accordance with a second embodiment of the disclosed and claimed concept that employs the fuse of FIG. 1;

FIG. 4 is a perspective view, partially cut away, of an improved protection device in accordance with a third embodiment of the disclosed and claimed concept that employs the fuse of FIG. 1; and

FIG. 5 is a perspective view, partially cut away, of an improved protection device in accordance with a fourth embodiment of the disclosed and claimed concept that can employ the fuse of FIG. 1 or the protection device of FIG. 3 or 4.

Similar numerals refer to similar parts throughout the specification.

### DESCRIPTION

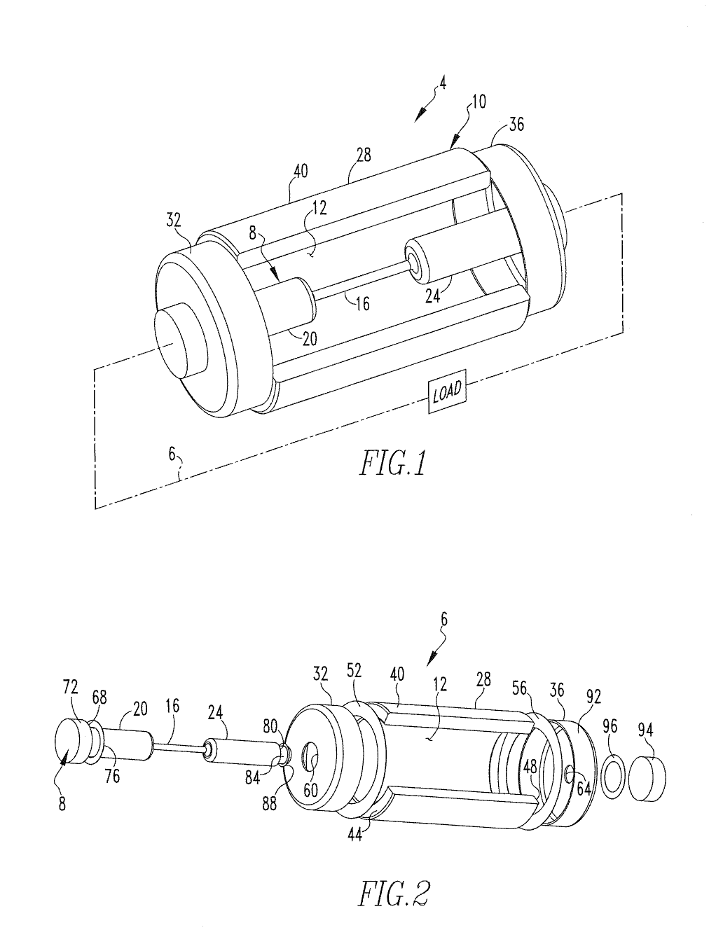

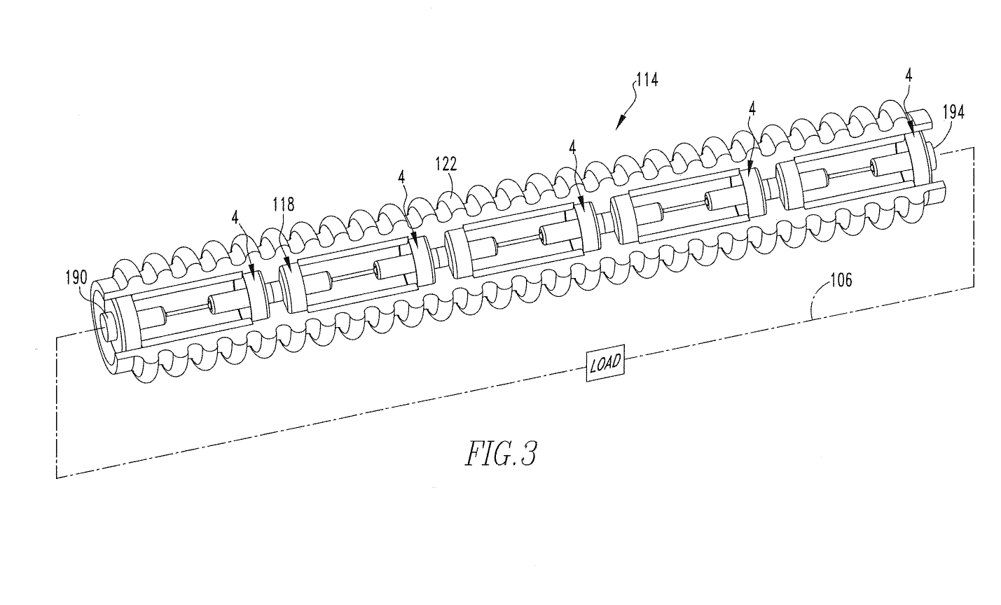

An improved fuse 4 in accordance with a first embodiment of the disclosed and claimed concept is depicted in a partially cut away fashion in FIG. 1 and is depicted in a partially cut away and exploded fashion in FIG. 2. The fuse 4 is usable in a circuit 6 (schematically depicted in FIG. 1) in order to protect, for example, a protected device or the circuit itself in a current overload condition or other condition.

As can be understood from FIGS. 1 and 2, the fuse 4 is constructed from a fusible assembly 8 and an envelope 10 having a hollow interior region 12 that are joined together in a vacuum furnace to form the fuse 4. After formation in the vacuum furnace, the envelope 10 has a reduced pressure or a vacuum within the interior region 12. The vacuum within the interior region 12 enhances the performance of the fuse 4 because the vacuum provides enhanced arc extinction capability such as in the nature of a vacuum interrupter, albeit operable only once before requiring replacement.

As can be best seen in FIG. 2, the fusible assembly 8 includes a fusible element 16 that is electrically interposed between a pair of electrodes 20 and 24. The fusible assembly 8 is a rigid, self-supporting structure that is formed of a conductive material. The exemplary depicted fusible assembly 8 is co-formed of a single piece of material wherein the fusible element 16 and the electrodes 20 and 24 are free of joints therebetween. The fusible assembly 8 could be machined, for example, from a single piece of copper or other appropriate conductive material, or it could be cast or otherwise formed. It is noted, however, that in other embodiments the fusible element 8 could be assembled by rigidly connecting together the fusible element 16 between the electrodes 20 and 24 such as by welding, brazing, etc., so long as the resulting fusible assembly 8 is rigid and self-supporting for reasons that will be set forth in greater detail below.

The envelope 10 can be said to include a case 28 and a pair of end seals 32 and 36, with the end seals 32 and 36 being affixed to the case 28. The case 28 includes a wall 40 which, in the depicted exemplary embodiment, is of an elongated annular configuration having a pair of openings 44 and 48 at the opposite ends thereof. The wall 40 is situated adjacent the interior region 12 as are the end seals 32 and 36. The end seal 32 has a hole 60 formed therein, and the end seal 36 has a hole 64 formed therein, and it can be seen that the hole 60 is of a larger diameter than the hole 64.

During the assembly operation, a pair of braze inserts 52 and 56 are provided between the case 28 and the end seals 32 and 36, respectively. The electrode 20 has a widened peripheral portion 72 that is of a relatively greater diameter and that is situated opposite the fusible element 16. The widened peripheral portion 72 forms a ledge 68 that is oriented transverse to the longitudinal extent of the electrode 20. A braze insert 76 is provided adjacent the ledge 68.

The electrode 24 has a narrowed peripheral portion 84 that is situated opposite the fusible element 16 and that forms a ledge 80 which is oriented transverse to the longitudinal extent of the electrode 24. A braze insert 88 is provided adjacent the ledge 80. As a general matter, the widened peripheral portion 72 and the narrowed peripheral portion 84 are situated opposite one another on the fusible assembly 8.

During the assembly process, therefore, the end seals 32 and 36 are received against the ends of the case 28 with the braze inserts 52 and 56 being interposed between the ends of the case 28 and the end seals 32 and 36, respectively. The fusible assembly 8 is inserted through the hole 60 until the ledge 68 of the electrode 20 engages an exterior surface of the end seal 32, with the braze insert 76 being interposed between the ledge 68 and the exterior surface, it being noted that the exterior surface is opposite the interior region 12. In such a situation, it can be seen that the narrowed peripheral portion 84 of the electrode 24 will also be received in the opening 48 with the ledge 80 being engaged with an interior surface of the end seal 36 and with the braze insert 88 being interposed between the ledge 80 and the interior surface. It is noted that the interior surface of the end seal 36 is adjacent the interior region 12.

The various components of the fuse 4 as thus arranged together are then placed into a fixture (not expressly depicted herein), and the fixture with the components of the fuse 4 being arranged as set forth above is placed in a vacuum furnace for a period of time, typically several hours. The vacuum furnace draws the air that had been situated in the interior region 12 out of the interior region 12 to create the vacuum within the interior region 12 while essentially simultaneously melting the braze inserts 52, 56, 76, and 88. While maintaining the vacuum within the vacuum furnace, the temperature in the vicinity of the fixture is then reduced to a point below the melting temperature of the braze inserts 52, 56, 76, and 88 to cause the previously molten braze inserts 52, 56, 76, and 88 to solidify into rigid braze joints that affix together the various components of the fuse 4 while maintaining the vacuum within the interior region 12. That is, the braze insert 76 forms a braze joint between the ledge 68 and the exterior surface of the end seal 32, the braze insert 52 forms a braze joint between the end seal 32 and the case 28, the braze insert 88 forms a braze joint between the ledge 80 and the interior surface of the end seal 36, and the braze insert 56 forms a braze joint between the end seal 36 and the case 28. Such braze joints affix the various components of the fuse 4 together while maintaining the vacuum within the interior region 12 to form the fuse 4.

The case 28 can be formed from any of a variety of materials such as ceramic materials or other insulative materials. The end seals 32 and 36 can be formed of any of a variety of materials and likely will be formed of a metallic material such as copper or other appropriate conductive material. The fusible assembly 8 is likewise formed of an electrically conductive material such as copper.

In the exemplary embodiment described herein wherein the fusible element 16 and the electrodes 20 and 24 are co-formed as a single piece of material that is free of joints therebetween, the fusible assembly 8 will almost certainly be formed of a single material. In the alternative embodiment suggested above wherein the fusible assembly 8 is assembled by conductively affixing together the fusible element 16 and the electrodes 20 and 24 as separate structures, the fusible element 16 potentially could be formed of a different material than the electrodes 20 and 24. In either such embodiment, one or more coatings of additional materials that are not expressly depicted herein can be received on the ends of the electrodes 20 and 24 at the transition between the fusible element 16 and the electrodes 20 and 24 to form contact elements. Such contact elements may provide properties such as enhanced extinction of any arc that may be formed between the electrodes 20 and 24 during operation of the fuse 4. Such contact elements may alternatively or additionally provides a smoother surface after the molten surface cools after arc exposure, which can resist a restrike of an arc between the electrodes 20 and 24, and can provide other benefits. Such contact elements are entirely optional in nature and may be provided depending upon the needs of the particular application with which the fuse 4 is used.

The end seal 36 can optionally be additionally provided with a connector 94 that is depicted in FIG. 1. In such a situation, the end seal 36 could be considered to include a cap portion 92 that is affixed to the case 28 with the braze insert 56 and to further include the connector 94 being affixed to an exterior surface of the cap portion 92 in the vicinity of the opening 48. Such affixation can occur with the use of a braze insert 96 that is received generally between the connector 94 and the cap portion 92, with the connector 94 and the braze insert 96 being received in the fixture with the other components of the fuse 4 prior to reception in the vacuum furnace. Alternatively, the connector 94 can be applied to the cap portion 92 after the formation operation that occurs in the vacuum furnace. The connector 94 can be configured to be of the same size as the widened peripheral portion 72 if it is desired to give the fuse 4 a symmetric arrangement. The connector 94 can be electrically connected with the circuit 6, and the widened peripheral portion 72 can be considered to operate as another connector that is likewise electrically connected with the circuit 6. In alternative embodiments that are not expressly depicted herein, the widened peripheral portion 72 and the connector 94 could be configured as cooperable male and female portions or could be of another cooperable arrangement that would enable a plurality of the fuses 4 to be connected together in series for reasons that will be set forth in greater detail below.

By providing the fusible assembly 8 as a rigid and self-supporting structure, the fusible assembly 8 can be received through the opening 44 until the narrowed peripheral region 84 is received in the hole 64. The rigid and self-supporting nature of the fusible assembly 8 enables the aforementioned fixture that is situated at the exterior of the various components of the fuse 4 to hold the various components of the fuse 4 in their desired relative positions, which enables the fuse 4 to be formed in a single run through the vacuum furnace. That is, the combination of the rigid and self-supporting fusible assembly 8 and the braze inserts 52, 56, 76, and 88 (and, optionally, 96) enables the fuse 4 to be formed in situ within the fixture as a single assembly that requires only a single run through the vacuum furnace to achieve such assembly. This advantageously reduces the cost of manufacturing the fuse 4 and provides other benefits that will be apparent.

An improved protection device 114 in accordance with a second embodiment of the disclosed and claimed concept is depicted generally in FIG. 3 in a partially cut away fashion. The protection device 114 is electrically connectable with a circuit 106 to protect the circuit 106 and/or a device within the circuit 106 from destruction due to excessive current flow.

The exemplary protection device 114 can be said to include a fuse apparatus 118 that includes a plurality of the fuses 4 being electrically connected together in series by electrically connecting together the electrodes 20 and 24 of pairs of adjacent fuses 4. The fuse apparatus 118 further includes an elongated support 122 upon which the plurality of fuses 4 are situated. The support 122 is elongated and serves as a container within which the fuses 4 are enclosed or upon which the fuses 4 are situated. The fuse apparatus 118 includes a connector 190 in the form of an electrode 20 of one of the fuses 4 that is not connected with another electrode 24 and that rather is exposed at the end of the fuse apparatus 118. The fuse apparatus 118 likewise includes another connector 194 opposite the connector 126 and that is in the form of the electrode 24 of the opposite fuse 4 that is unconnected with an electrode 20 and that is likewise exposed at the opposite end of the fuse apparatus 118 from the connector 126.

The exemplary support 122 is formed of a rigid insulative material having an exterior surface 134 that undulates between the connectors 190 and 194. Such undulations on the exterior surface 134 cause the exterior surface 134 to have a relatively greater distance along the exterior surface than the linear distance between the connectors 126 and 130. Such an increased distance along the exterior surface 134 provides for greater electrical insulation and isolation between the connectors 126 and 130.

The fuses 4 are depicted in FIG. 3 as being arranged end-to-end with adjacent electrodes 20 and 24 of adjacent pairs of fuses 4 being electrically connected together. Such electrical connection can occur simply by abutting the fuses 4 together, or the adjacent electrodes 20 and 24 could be brazed or otherwise electrically connected together depending upon the needs of the particular application. While the support 122 is depicted as being an elongated self-supporting structure, it is noted that in other embodiments the support 122 could instead be cured potting material within which the plurality of fuses 4 are situated or could be otherwise configured.

By providing the plurality of fuses 4 in series with one another, the various fusible elements 16 of the various fuses 4 will substantially simultaneously fuse or melt in a current overload condition, thereby forming a separate electrical arc between each set of electrodes 20 and 24 within each fuse 4. The current overload condition will likely be a rated minimum interruption level to enable simultaneous melting of the series-arranged fusible elements 16. Since the arcs each have an arc voltage that is opposite the circuit voltage, the series-arranged plurality of electrical arcs together have an additive and thus very large arc voltage that resists the circuit voltage and thus interrupts the overload current flowing in the circuit 106. The protection device 114, being composed of a plurality of series connected and reduced- cost fuses 4, is likewise of a relatively low cost compared with the enhanced performance provided thereby.

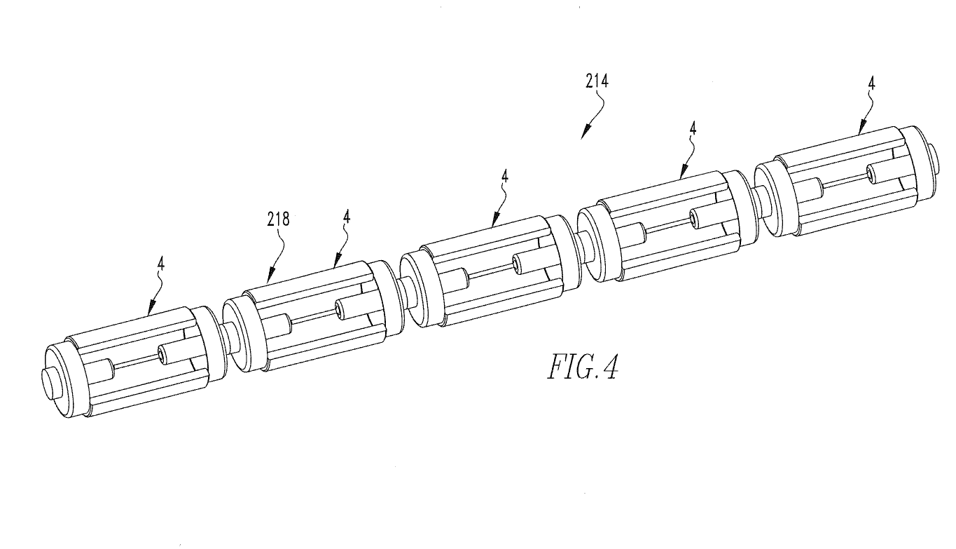

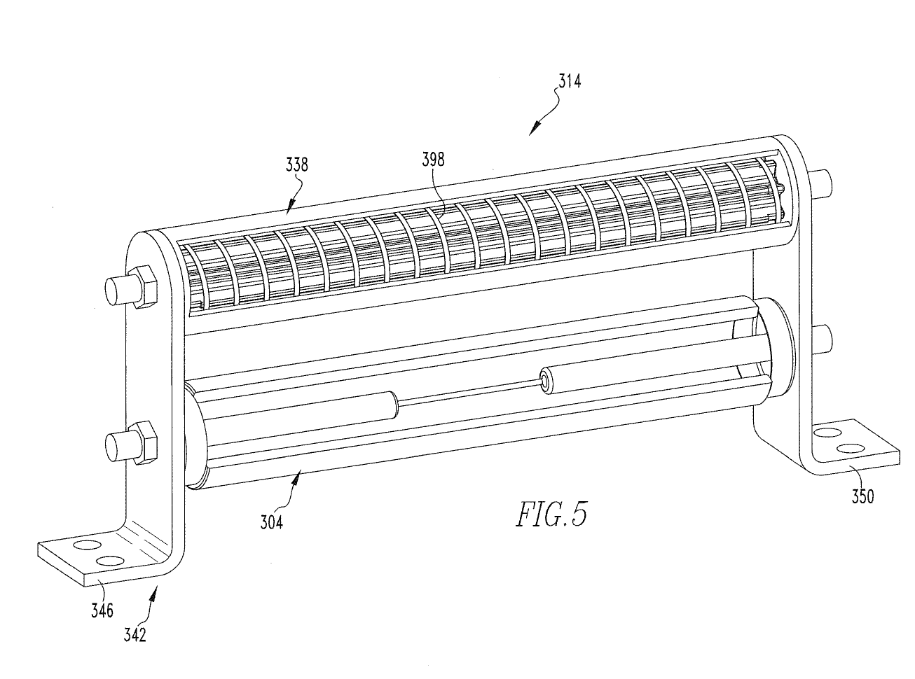

An alternative protection device 214 in accordance with a third embodiment of the disclosed and claimed concept is depicted in FIG. 4 as including a fuse apparatus 218 that comprises a plurality of the fuses 4 electrically connected together in series. The protection device 214 does not employ a separate support, but rather the fuses 4 are each rigidly connected to one another, such as by brazing, such that the fuse apparatus 218, and thus the protection device 214, is a rigid and self-supporting assembly. The protection device 214 thus is usable on its own or can be situated within cured potting material as suggested above. The series-connected fuses 4, when operated, provide a plurality of series-arranged arcs that together provide an overall arc voltage that opposes the circuit voltage and which interrupts the current in the circuit that is connected therewith.

The plurality of fuses 4 in either of the protection devices 114 and 214 potentially could be brazed together in the same single furnace run mentioned above wherein the fuses 4 themselves are likewise formed. That is, an elongated fixture could hold in a series arrangement a plurality of the assembled but unformed fuses 4 and could additionally employ braze inserts situated between adjacent electrodes 20 and 24 of adjacent pairs of fuses 4. The elongated fixture could then be processed in a single furnace run to form the fuses 4 themselves and to form the braze connections between the adjacent fuses 4 to cause the plurality of series-connected fuses 4 to be of a rigid and self-supporting nature. It is understood, however, that any of a variety of formation methodologies can be employed to form the protection devices 114 and 214.

The plurality of series-connected fuses 4 in each of the protection devices 114 and 214 thus provides enhanced interruption performance at a reduced cost. One such significant advantage is that the series arrangement of the fuses 4 in each of the protection devices 114 and 214 allows much higher voltage ratings—into the high voltage class of fuses. Other advantages will be apparent.

An improved protection device 314 in accordance with a fourth embodiment of the disclosed and claimed concept is depicted in a partially cut away fashion in FIG. 5. The protection device 314 comprises a current limiting fuse 338 and a non-current limiting fuse 304 that are situated on an electrical connection apparatus 342 that electrically connects together in a parallel arrangement the current limiting fuse 338 and the non-current limiting fuse 304. In the depicted exemplary embodiment, the electrical connection apparatus 342 includes a pair of bus bars 346 and 350 with which the current limiting fuse 338 and the non-current limiting fuse 304 are each electrically connected.

The current limiting fuse 338 is depicted as including an elongated fusible element 398 that is wound in a helical fashion within the interior of the current limiting fuse 338 between a pair of electrodes. The current limiting fuse 338 can be generally any type of current limiting fuse that provides current interruption at short circuit current levels.

The non-current limiting fuse 304 is depicted as being a single one of the fuses 4 that is electrically connected between the bus bars 346 and 350. The non-current limiting fuse 304 could likewise be one of the protection devices 114 or 214, by way of example. It is reiterated that the non-current limiting fuse 304 is a vacuum fuse in the fashion set forth above.

The protection device 314 can be said to be a vacuum commutating current limiting fuse because it provides the advantages of both the current limiting fuse 338 and the vacuum non-current limiting fuse 304. The protection device 314 can be deployed to protect a circuit.

In operation, the current limiting fuse 338 has a substantially higher resistance than the non-current limiting fuse 304, with the result that the vast majority of the current flowing through the protection device 314, such as 95%, will flow through the non-current limiting fuse 304. The remaining current, such as 5%, will flow through the current limiting fuse 338 during such normal use of the protection device 314. In the event of an anticipated high current event, such as an anticipated motor startup or other such event, 95% (for example) of the increased current will flow through the non-current limiting fuse 304 without causing it to operate, i.e., without causing it to melt or fuse, thereby providing sustained electrical connectivity during such a transitory high current situation. Since the vast majority (95% for example) of the transitory overload current travels through the non-current limiting fuse 304, the remaining 5% (for example) of the transitory overload current that flows through the current limiting fuse 338 has very little effect on it. Such 5% (for example) of the transitory overload current thus does not cause the current limiting fuse 338 to operate.

However, when the current flowing through the protection device 314 begins to rise toward a sustained overload current level and thereafter toward a short circuit current level, the majority of such current (95% for example), which will have been flowing through the non-current limiting fuse 304, will begin to cause its fusible element to fuse or melt. As such fusing or melting of the non-current limiting fuse 304 begins and continues, progressively greater amounts of the overall current flowing through the protection device 314 will instead begin to flow through the current limiting fuse 338. When the fusible element of the non-current limiting fuse 304 finally fuses, all of the current in the protection device 314 will flow through the current limiting fuse 338 thereby causing the current limiting fuse 338 to operate in its usual current limiting fashion to interrupt the high current that is flowing through the protection device 314. Upon such operation of the current limiting fuse 338, any electrical arc that may have formed between the electrodes of the non-current limiting fuse 304 will have already been extinguished and cannot therefore reform after operation of the current limiting fuse 338. It is noted that such an arc between the electrodes of the non-current limiting fuse 304 is unlikely to form upon melting of its fusible element since the current that had been flowing through the non-current limiting fuse 304 will instead flow through the current limiting fuse 338 and thus will not have a tendency to form an arc through the non-current limiting fuse 304.

It therefore can be seen that the protection device 314 provides the benefits of both the current limiting fuse 338 and the non-current limiting fuse 304 while avoiding some of the shortcomings of both. For example, an anticipated transitory high current flow through the protection device 314, such as in the event of a motor startup or other event, will flow to a large extent (i.e., 95% of the current) through the non-current limiting fuse 304, which will be configured to withstand such anticipated overcurrent events. This will advantageously avoid operation of the current limiting fuse 338 in such an anticipated event. Moreover, the current limiting fuse 338 connected in parallel with the non-current limiting fuse 304 will provide the enhanced capability of interrupting short circuit level current levels that may be experienced by the protection device 314.

In this regard, since anticipated transitory current overload does not cause the current non-current limiting fuse 304 to operate, i.e., fuse, and likewise does not cause the current limiting fuse 338 to operate, it can be seen that excessive effort need not be expended to fine tune the specifications of the current limiting fuse 338. That is, as suggested above, a current limiting fuse in a circuit typically must be carefully selected in order to withstand anticipated transitory high currents while interrupting short circuit currents, and such effort can be time consuming and expensive. However, since the protection device 314 provides the non-current limiting fuse 304 in addition to the current limiting fuse 338, transitory high current levels in the protection device 314 are carried by the current non-limiting fuse 304 (at least, say, 95% of such current), which would barely affect the current limiting fuse 338. As such, any of a large variety of current limiting fuses 338 could be usable in conjunction with the non-current limiting fuse 304 to provide the ability to interrupt short circuit current levels without the need to additionally configure the current limiting fuse 338 to itself withstand such transitory overload current levels. It is reiterated, however, that by providing the current limiting fuse 338 and the non-current limiting fuse 304 in parallel, the protection device 314 still provides the ability to interrupt short circuit current levels.

It thus can be seen that the protection device 314 provides an enhanced range of performance at reduced cost. The vacuum non-current limiting fuse 304 can withstand transitory overload current levels without the current limiting fuse 338 being affected thereby. Moreover, the protection device 314 can still provide short circuit interruption capability. Other advantages will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A protection device structured to be electrically connected with a protected portion of an electrical circuit, the protection device comprising:
a current limiting fuse structured to interrupt a short circuit current;
a non-current limiting fuse structured to interrupt an overload current and comprising an envelope having a hollow interior region, a pair of electrodes, and a fusible element, the pair of electrodes being situated on the envelope, the fusible element being electrically interposed between the pair of electrodes, the fusible element being situated within the interior region, the interior region having a reduced pressure therein; and
an electrical connection apparatus that electrically connects together in parallel the current liming fuse and the non-current limiting fuse.

2. The protection device of claim 1 wherein the electrical connection apparatus comprises a pair of bus bars, the current liming fuse and the non-current limiting fuse each being electrically connected with each bus bar of the pair of bus bars.

3. The protection device of claim 1 wherein, for each of at least some of the fuses of the plurality of fuses:
the envelope comprises a case and a pair of end seals;
the case comprises at least a first wall and has a pair of openings;
the least first wall is situated adjacent the interior region;
the pair of end seals each have a hole formed therein, the end seals each being affixed to the case and overlying an opening of the pair of openings; and
the element and the pair of electrodes are affixed together to form a rigid and self-supporting fusible assembly that is received in the holes and is affixed to the end seals.

4. The protection device of claim 3 wherein the fusible assembly is substantially free of joints between the fusible element and the pair of electrodes.

5. The protection device of claim 3 wherein the fusible element and the pair of electrodes co-formed as a single piece structure that is substantially free of joints.

6. The protection device of claim 3 wherein the fusible element and the pair of electrodes are formed separately and are rigidly connected together.

7. The protection device of claim 3 wherein an electrode of the pair of electrodes includes a ledge that is received against an exterior surface of an end seal of the pair of end seals in a region peripheral to the hole formed in the end seal.

8. The protection device of claim 7 wherein the ledge is affixed to the external surface in the region peripheral to the hole.

9. The protection device of claim 7 wherein the other electrode, the fusible element, and at least a portion of the electrode are sized to be received through the hole in the end seal.

10. The protection device of claim 9 wherein at least a portion of the other electrode is sized to be received through the hole formed in another end seal of the pair of end seals.

11. The protection device of claim 10 wherein the other electrode comprises another ledge that is received against an interior surface of the another end seal in a region peripheral to the hole formed therein, the interior surface being adjacent the interior region.
